(19) United States
(12) Patent Application Publication
(10) Pub. No.: US 2024/0078687 A1
(43) Pub. Date: Mar. 7, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Tomoaki ARAI, Tokyo (JP)

(21) Appl. No.: 18/307,899

(22) Filed: Apr. 27, 2023

(30) Foreign Application Priority Data
May 17, 2022 (JP) 2022-080977

(51) Int. Cl. G06T 7/292; G06F 3/04815; G06T 7/215; G06T 7/70; G06T 19/00; H04N 23/60

(52) U.S. Cl. CPC G06T 7/292; G06F 3/04815; G06T 7/215; G06T 7/70; G06T 19/00; H04N 23/60; G06T 2207/30241; G06T 2207/30244

(57) ABSTRACT

An information processing apparatus: receives an instruction related to a virtual viewpoint for generating a virtual viewpoint image; generates, in a case where the received instruction includes an instruction to switch from a first virtual viewpoint to a second virtual viewpoint, switching information indicating a positional relationship between the first virtual viewpoint and a first object included in a virtual viewpoint image corresponding to the first virtual viewpoint; changes, based on the generated switching information, a positional relationship between the second virtual viewpoint and a second object included in a virtual viewpoint image corresponding to the second virtual viewpoint to be similar to the positional relationship between the first virtual viewpoint and the first object; and generates a virtual viewpoint image corresponding to the second virtual viewpoint changed according to the changed positional relationship.

### BACKGROUND

### Field

The present disclosure relates to a technique to generate a virtual viewpoint image.

### Description of the Related Art

There has been a technique to generate an image (virtual viewpoint image) expressing a view from a virtual viewpoint designated by manipulation by a user, the technique including: disposing multiple image-capture devices at different positions for synchronous image-capturing; and using multiple image-captured images obtained from the image-capturing. For example, while referring to the virtual viewpoint image corresponding to the virtual viewpoint from which a desired object (interest object) is captured, the user performs manipulation to switch the virtual viewpoint and to change a line-of-sight direction from the virtual viewpoint. Japanese Patent Laid-Open No. 2018-092491 discloses a technique to determine how to move the virtual viewpoint after the virtual viewpoint is switched by manipulation by the user based on how the virtual viewpoint is moved in accordance with manipulation by the user that is received before switching.

### SUMMARY

However, in a case of Japanese Patent Laid-Open No. 2018-092491, if the virtual viewpoint is switched to image-capture a second interest object in the same image-capture space, motions of the virtual viewpoint and the second interest object after switching may be different from each other. If there is such a difference in the motions, there is a possibility that sight of the second interest object is lost after switching the virtual viewpoint, and it affects manipulation of the virtual viewpoint after switching. For example, if the virtual viewpoint before switching is moving straight in a specific direction, the virtual viewpoint after switching also moves straight in the specific direction as with the virtual viewpoint before switching. In this case, if the second interest object is moving straight in opposite direction of the specific direction, the virtual viewpoint after switching and the second interest object move straight in directions opposite from each other. Therefore, in some cases, the second interest object immediately moves to the outside of an image-capture range from the virtual viewpoint after switching, and sight of the second interest object is lost in a virtual viewpoint image corresponding to the virtual viewpoint after switching. Additionally, in some cases, even if the first interest object is shown in the center in the virtual viewpoint image before the virtual viewpoint is switched, the second interest object is shown at a right end or the like in the virtual viewpoint image after switching. If the positions and the like of the first and second interest objects shown in the virtual viewpoint image are different as described above, there is a possibility that the user cannot appropriately figure out a line-of-sight direction from the virtual viewpoint after switching and the like immediately after switching the virtual viewpoint, which causes loss of a sense of direction, and cannot smoothly start manipulation of the virtual viewpoint after switching. Moreover, even in a case of capturing the same interest object from the virtual viewpoints before and after switching, a similar problem could occur as a case of capturing different objects from the virtual viewpoints before and after switching.

An information processing apparatus according to an aspect of the present disclosure includes: one or more memories storing instructions; and one or more processors executing the instructions to: receive an instruction related to a virtual viewpoint for generating a virtual viewpoint image; generate, in a case where the received instruction includes an instruction to switch from a first virtual viewpoint to a second virtual viewpoint, switching information indicating a positional relationship between the first virtual viewpoint and a first object included in a virtual viewpoint image corresponding to the first virtual viewpoint; change, based on the switching information, a positional relationship between the second virtual viewpoint and a second object included in a virtual viewpoint image corresponding to the second virtual viewpoint to be similar to the positional relationship between the first virtual viewpoint and the first object; and generate a virtual viewpoint image corresponding to the second virtual viewpoint changed according to the changed positional relationship.

Further features of the present disclosure will become apparent from the following description of exemplary embodiments with reference to the attached drawings.

### BRIEF DESCRIPTION OF THE DRAWINGS

FIG. 1 is a diagram illustrating a schematic configuration example of an image processing system;

FIG. 2 is a diagram illustrating a detailed configuration example of the image processing system;

FIG. 3 is a diagram illustrating a display example of a display device in a user terminal;

FIG. 4 is a diagram illustrating a configuration example of virtual viewpoint manipulation information;

FIG. 5 is a diagram illustrating a hardware configuration example of devices;

FIG. 6 is a diagram illustrating a functional configuration example of an information processing apparatus;

FIG. 7 is a diagram illustrating a configuration example of object information;

FIG. 8 is a flowchart illustrating a flow of processing executed by the information processing apparatus;

FIG. 9 is a diagram describing switching of a virtual viewpoint;

FIG. 10 is a flowchart illustrating a detailed flow of processing to generate pre-switching information;

FIG. 11 is a diagram describing a method of calculating an angle formed between a traveling direction of a first main object and a virtual viewpoint direction;

FIGS. 12A and 12B are diagrams describing a method of correcting an angle of a pan direction;

FIG. 13 is a flowchart illustrating a detailed flow of processing to change a position and a line-of-sight direction of the virtual viewpoint after switching;

FIG. 14 is a diagram describing a method of changing the position of the virtual viewpoint after switching;

FIG. 15 is a diagram describing a method of correcting the position and the line-of-sight direction of the virtual viewpoint after switching;

FIGS. 16A to 16D are diagrams illustrating a relationship between a body height of a main object and a virtual viewpoint image corresponding to the virtual viewpoint after switching;

FIG. 17 is a flowchart illustrating a detailed flow of processing to control movement of the virtual viewpoint;

FIG. 18 is a diagram describing transition of the virtual viewpoint; and

FIGS. 19A and 19B are diagrams illustrating virtual viewpoint image examples corresponding to the virtual viewpoints before and after switching.

### DESCRIPTION OF THE EMBODIMENTS

First, an overview of a virtual viewpoint image is described in advance to describe an embodiment of the present disclosure. According to a service using the virtual viewpoint image, for example, it is possible to provide viewers higher realistic sensation than a usual image-captured image does because the viewers can watch a specific scene (for example, a goal scene and the like) in a game of soccer, basketball, and so on from various angles. In generation of the virtual viewpoint image, an information processing apparatus (image processing apparatus) such as a server aggregates data of multiple image-captured images obtained by image-capturing specific positions in a space as an image-capture target by multiple image-capture devices (hereinafter, referred to as multi-viewpoints image data). The information processing apparatus then uses the multi-viewpoints image data to generate the virtual viewpoint image by generating three-dimensional shape data and performing rendering processing and transmits data of the generated virtual viewpoint image (hereinafter, referred to as “virtual viewpoint image data”) to a user terminal. Therefore, the user can browse the virtual viewpoint image displayed on a display device in the user terminal based on the virtual viewpoint image data.

Additionally, the user can manipulate a position of a virtual viewpoint and a direction of line-of-sight from the virtual viewpoint including pan, tilt, and roll and can browse a first interest object desired to browse from a favorable viewpoint. For example, in a case of a scene in which one soccer player makes dribbling and scores a shot, it is possible to perform manipulation to follow behind the player from the virtual viewpoint and turn the virtual viewpoint to the front of the player in the timing of shooting. Note that, descriptions are given below under the definition that data indicating the position of the virtual viewpoint and the direction of line-of-sight from the virtual viewpoint in chronological order that are designated by manipulation by the user, like the above-described example, is virtual viewpoint manipulation information.

An embodiment of a technique of the present disclosure is described below in detail with reference to the appended drawings. Note that, the following embodiment is not intended to limit the technique of the present disclosure according to the scope of claims, and not all the combinations of the characteristics described in the present embodiment are necessarily essential for the means for solving the problems of the technique of the present disclosure. Note that, the same constituents are denoted by the same reference numerals, and descriptions are omitted.

### Embodiment 1

### [System Configuration]

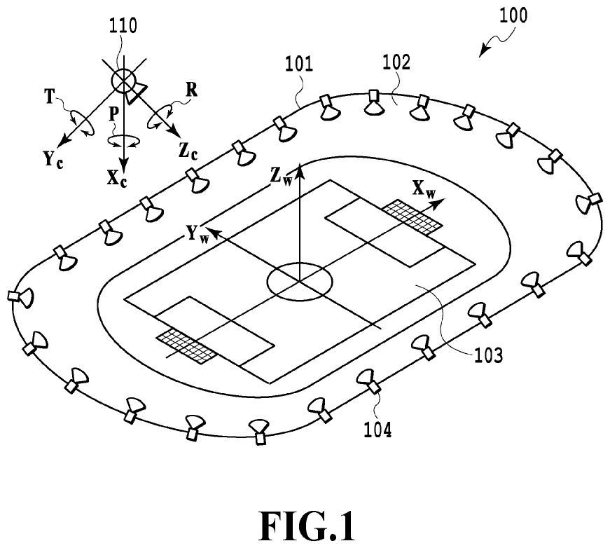

FIG. 1 is a diagram illustrating a schematic configuration example of an image processing system 100 according to the present embodiment. The image processing system 100 includes multiple image-capture devices 104 disposed in a stadium 101 such as a soccer field. The stadium 101 includes a field 103 in which a competition and the like are actually held and seats 102 surrounding the field 103. The multiple image-capture devices 104 are arranged to surround the seats 102 and the field 103.

In the present embodiment, descriptions are given under the following definition of a world coordinate system (X axis, Y axis, and Z axis). That is, where the center of the field 103 is an origin, a longer side direction in the field is the X axis, a shorter side direction in the field is the Y axis, and an orthogonal direction with respect to the X axis and the Y axis is the Z axis. Additionally, the X axis, the Y axis, and the Z axis of the world coordinate system are displayed as Xw, Yw, and Zw, respectively. A direction of an arrow of each axis of Xw, Yw, and Zw illustrated in FIG. 1 represents a plus direction.

Additionally, in the present embodiment, descriptions are given under the following definition of a virtual camera coordinate system in order to determine a direction of a view from a virtual camera 110. That is, where the optical center of the virtual camera 110 is an origin, an optical axis direction is the Z axis, a transverse direction (right and left direction) of the virtual camera 110 is the X axis, and a longitudinal direction (up and down direction) of the virtual camera 110 is the Y axis. Additionally, the X axis, the Y axis, and the Z axis of the virtual camera coordinate system are displayed as Xc, Yc, and Zc, respectively. A direction of an arrow of each axis of Xc, Yc, and Zc illustrated in FIG. 1 represents a plus direction.

Note that, the above-described definitions of the world coordinate system and virtual camera coordinate system are examples, and the world coordinate system and the virtual camera coordinate system may be defined by another method.

Directions of the virtual camera 110 are indicated by rotation around an axis in an up and down direction with respect to the orientation of the virtual camera (pan), rotation around an axis in a right and left direction with respect to the orientation of the virtual camera (tilt), and rotation around an axis in a front and rear direction with respect to the orientation of the virtual camera (roll). That is, pan P is a parameter indicating that an optical axis of the virtual camera 110 is rotated in the right and left direction and is rotation of the virtual camera 110 around a pan axis. Tilt T is a parameter indicating that the optical axis of the virtual camera 110 is rotated in the up and down direction and is rotation of the virtual camera 110 around a tilt axis. Roll R is a parameter indicating rotation about the optical axis of the virtual camera 110 and is rotation of the virtual camera around a roll axis.

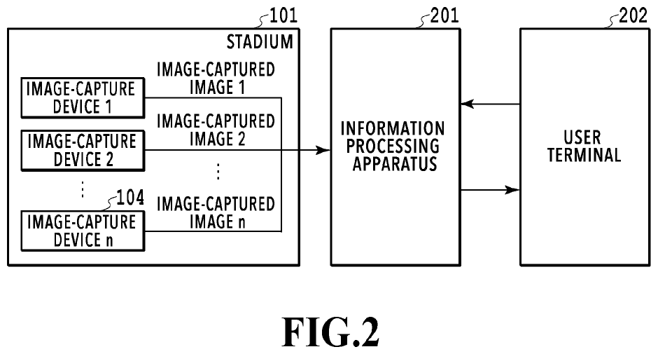

FIG. 2 is a diagram illustrating a detailed configuration example of the image processing system. The image processing system 100 includes the multiple image-capture devices 104 disposed in the stadium 101, an information processing apparatus 201, and a user terminal 202.

The multiple image-capture devices 104 are arranged so as to each image-capture at least a part of or all the range of the field 103, which is an image-capture target region, and also to make overlapping between viewing angles of at least two image-capture devices. For example, the multiple image-capture devices 104 are connected with each other through a transmission cable. Additionally, the image-capture devices 104 are disposed to face gaze points of one or more actual image-capture devices set in advance. That is, each of the gaze points of the one or more actual image-capture devices is image-captured by the two or more image-capture devices 104 from different directions. The multiple image-capture devices 104 are also connected to the information processing apparatus 201 and transmit images obtained by image-capturing the field 103 to the information processing apparatus 201.

Note that, the multiple image-capture devices 104 may be an image-capture device that image-captures a still image, an image-capture device that image-captures a moving image, or an image-capture device that image-captures a still image and a moving image. Additionally, in the present embodiment, unless stated otherwise, the term “image” includes both the still image and moving image.

The information processing apparatus 201 is an apparatus that generates a virtual viewpoint image. The virtual viewpoint image in the present embodiment is something also called a free viewpoint video and is an image corresponding to a viewpoint designated freely (arbitrarily) by a user. However, it is not limited thereto, and an image corresponding to a viewpoint selected from multiple candidates by the user and the like are also included in the virtual viewpoint image, for example. Additionally, although a case where the virtual viewpoint image is a moving image is mainly described in the present embodiment, the virtual viewpoint image may be a still image. Moreover, the virtual viewpoint may be designated by manipulation by the user or may be automatically designated by a device. In the present embodiment, an example in which the later-described information processing apparatus changes the virtual viewpoint is described.

The user terminal 202 is an information processing apparatus owned by the user who uses the image processing system 100 such as, for example, a viewer who manipulates the user terminal 202. The user terminal 202 is, for example, a personal computer or a mobile terminal such as a smartphone and a tablet. The user terminal 202 includes an interface to receive manipulation by the user such as at least one of a mouse, a keyboard, a joystick, and a touch panel. Additionally, the user terminal 202 receives the virtual viewpoint image from the information processing apparatus 201 and displays the virtual viewpoint image on a built-in (or external in some situations) display device.

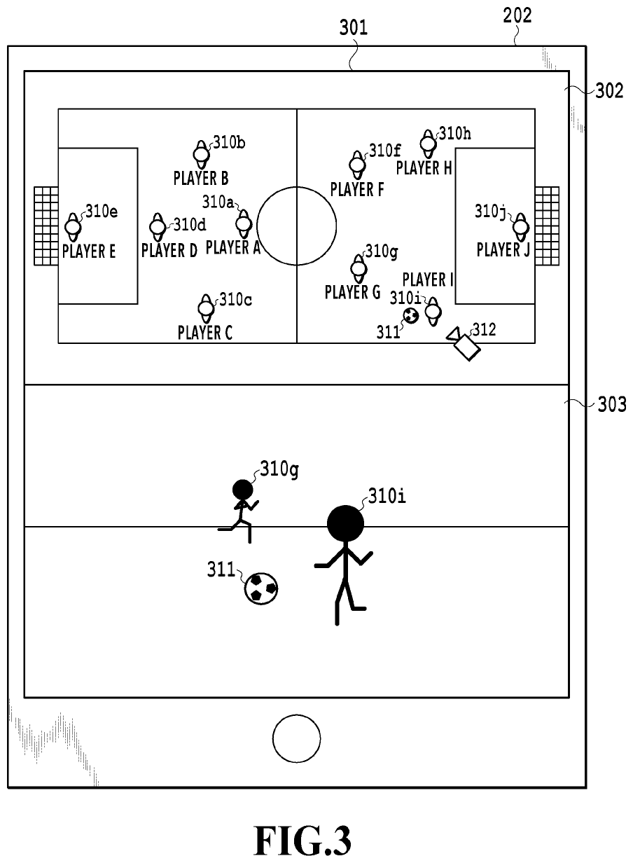

FIG. 3 is a diagram illustrating a display example of the display device in the user terminal 202. The user terminal 202 is a mobile terminal such as a smartphone and a tablet. The user terminal 202 includes a display device 301 and displays the virtual viewpoint image received from the information processing apparatus 201. The display device 301 displays two screens, a switching screen 302 and a manipulation screen 303.

The switching screen 302 displays the virtual viewpoint image of the field 103 viewed from directly above (hereinafter, referred to as a bird's-eye image in some cases). The bird's-eye image may be an image showing all the targets, which are a player, a referee, and a soccer ball, or may be an image showing a referee, a soccer ball, and a main player. The user can figure out respective positions of players 310a to 310j, a ball 311, and a virtual viewpoint 312 in the field by watching the bird's-eye image on the switching screen 302. Additionally, a player name corresponding to each player is displayed around the corresponding player, and the position of the player name displayed correspondingly to the player is also moved in accordance with motion of the player. The virtual viewpoint 312 is displayed as an icon of the image-capture device. The user can select a player on the bird's-eye image displayed on the switching screen 302 by instructing (tapping) with a finger and thus can immediately move (switch) the virtual viewpoint 312 to a position in which the selected player is image-captured as a second object, which is a main object after switching. That is, it is possible to switch from the virtual viewpoint 312 before switching, from which a first object as the main object is captured, to the virtual viewpoint after switching, from which the second object as the main object is captured.

The manipulation screen 303 is a virtual viewpoint image (hereinafter, called a manipulation image in some cases) 303 that is generated based on a position of the virtual viewpoint 312 and a line-of-sight direction from the virtual viewpoint 312 in the bird's-eye image displayed on the switching screen 302 and indicates a visual field boundary of the virtual viewpoint 312. The user can control the position of the virtual viewpoint 312 and the line-of-sight direction from the virtual viewpoint 312 by touching and manipulating the manipulation image displayed on the manipulation screen 303.

With use of the user terminal 202, for example, in the middle of targeting the player 310i to image-capture from the virtual viewpoint 312, the user can perform manipulation to immediately move the virtual viewpoint 312 to the player 310b and target the player 310b to image-capture from the virtual viewpoint after the movement. That is, with use of the user terminal 202 displaying the switching screen 302 and the manipulation screen 303, the user can perform manipulation to switch the virtual viewpoint 312 before switching, from which the player 310i is captured, to the virtual viewpoint after switching, from which the player 310b is captured.

Note that, although a case where the display device in the user terminal 202 includes two screens is described, it is not limited thereto. For example, a dual display may be applicable. In this case, the dual display may be used in an aspect in which the switching screen is displayed on one display while the manipulation screen is displayed on the other display. Additionally, although an aspect in which the bird's-eye image of the field viewed from directly above is displayed on the switching screen 302, and a desired player is selected in the bird's-eye image is described, it is not limited thereto. For example, an aspect in which a list table indicating a list of player names of players that can be associated with the virtual viewpoint after switching is displayed, and a desired player is selected from the list table may be applicable.

Based on manipulation by the user (user input) on the manipulation screen 303, the user terminal 202 receives a manipulation instruction related to the position of the virtual viewpoint and the line-of-sight direction from the virtual viewpoint. The user terminal 202 transmits virtual viewpoint manipulation information indicating the details of the manipulation instruction to the information processing apparatus 201 every time there is a change in the position of the virtual viewpoint and the line-of-sight direction from the virtual viewpoint.

### <Virtual Viewpoint Manipulation Information>

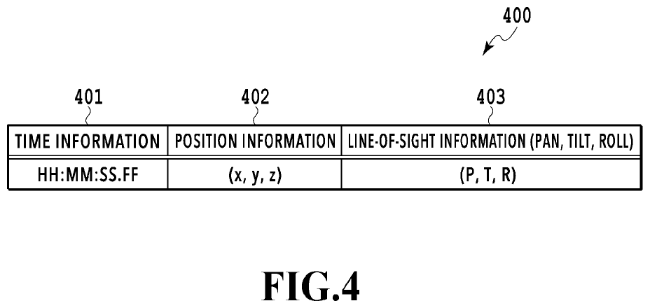

Details of the virtual viewpoint manipulation information are described with reference to a drawing. FIG. 4 is a diagram illustrating a configuration example of the virtual viewpoint manipulation information. Virtual viewpoint manipulation information 400 includes time information 401, position information 402, and line-of-sight information 403. Note that, hereinafter, the position information 402 and the line-of-sight information 403 may be collectively called position line-of-sight information. The time information 401 is information indicating the same time as image-capture time at which the image-capture device performs image-capturing. The time information 401 is information indicating time at a certain time point that is expressed as HH(hour):MM(minute):SS(second).FF(frame). The position information 402 is information indicating the position of the virtual viewpoint at the time indicated by the time information 401. The position information is information indicating the position of the virtual viewpoint that is expressed by three-dimensional orthogonal coordinate in a coordinate system in which three coordinate axes (for example, X axis, Y axis, and Z axis) in different axial directions cross orthogonal to each other at an origin. As the origin, for example, an arbitrary position in the image-capture target space of the multiple image-capture devices such as a central position of a center circle in the field 103 is designated. The line-of-sight information 403 is information indicating the line-of-sight direction from the virtual viewpoint at the time indicated by the time information 401. The line-of-sight information 403 is information indicating the line-of-sight direction from the virtual viewpoint and the like that is expressed by an angle with respect to the three axes of pan (horizontal direction), tilt (perpendicular direction), and roll (direction in which the optical system of the image-capture device is rotated at a plane orthogonal to the optical axis).

Additionally, in a case where an instruction to switch the virtual viewpoint (virtual camera) is received through the switching screen 302, the user terminal 202 transmits the following information to the information processing apparatus 201 with the switching request (switching instruction). That is, the user terminal 202 transmits object identification information, which is information on a second interest object captured from the virtual viewpoint (virtual camera) after switching, to the information processing apparatus 201. The object identification information includes a name of the object and an object identification ID. The object identification ID is formed of an alphabet and a number and is an identification symbol allocated to distinguish each object.

Moreover, the information processing apparatus 201 accumulates the images that are image-captured by the multiple image-capture devices 104 (hereinafter, the images that are image-captured are called “image-captured images” in some cases). The information processing apparatus 201 generates the virtual viewpoint image by using the images obtained by image-capturing by the multiple image-capture devices 104.

The information processing apparatus 201 generates the bird's-eye image in which the field 103 is viewed from directly above. On the bird's-eye image, the information processing apparatus 201 superimposes and displays the icon of the image-capture device indicating the position of the virtual viewpoint. The information processing apparatus 201 moves the icon of the image-capture device based on the virtual viewpoint manipulation information received from the user terminal 202. Additionally, around a player on the bird's-eye image, the information processing apparatus 201 superimposes and displays a player name corresponding to the player. The information processing apparatus 201 controls movement of the player name corresponding to the player so as to follow the motion of the player.

Based on the virtual viewpoint manipulation information received from the user terminal 202, the information processing apparatus 201 generates the virtual viewpoint image (manipulation image) indicating the visual field boundary of the virtual viewpoint manipulated by the user. The manipulation image is an image corresponding to the visual field boundary of the virtual viewpoint in which the icon of the image-capture device on the bird's-eye image is positioned. In a case where the switching request (switching instruction) is received from the user terminal 202, the information processing apparatus 201 obtains the object identification information associated with the switching request. Note that, in a case where a specific place of the field is designated instead of a desired player by manipulation by the user, the object identification information corresponding to a player that satisfies predetermined conditions based on the designated specific place is associated with the switching request. The object identification information in this case may be, for example, information corresponding to a player (object) nearest the designated specific place. Additionally, if there are multiple players (objects) nearest the designated specific place, the object identification information corresponding to a player (object) having a predetermined high priority may be associated with the switching request. The information processing apparatus 201 obtains the position information on the object indicated by the object identification information and switches the screen to the manipulation screen of the virtual viewpoint moved to the position indicated by the position information. In this case, the information processing apparatus 201 automatically sets the position and the line-of-sight direction of the virtual viewpoint after switching such that a view from the virtual viewpoint capturing the player before switching (first object) and a view from the virtual viewpoint capturing another player after switching (second object) are the same. That is, the position of the virtual viewpoint after switching and the line-of-sight direction from the virtual viewpoint after switching are automatically set such that the virtual viewpoint image from the virtual viewpoint after switching is an image having a composition similar to the composition of the virtual viewpoint image from the virtual viewpoint before switching. Additionally, the information processing apparatus 201 generates the virtual viewpoint image (manipulation image) corresponding to the automatically set position of the virtual viewpoint and the automatically set line-of-sight direction from the virtual viewpoint.

The information processing apparatus 201 transmits the generated bird's-eye image and manipulation image to the user terminal 202.

The information processing apparatus 201 is, for example, a server apparatus, and includes a database function to store the multiple image-captured images and the generated virtual viewpoint image and an image processing function to generate the virtual viewpoint image. Additionally, the multiple image-capture devices 104 in the stadium 101 and the information processing apparatus 201 are connected with each other by a wired or wireless communication network line or a cable line such as an serial digital interface (SDI). The information processing apparatus 201 receives the image obtained by image-capturing by the multiple image-capture devices 104 through the above-described line and stores the received image into a database.

The information processing apparatus 201 and the user terminal 202 are formed such that, for example, it is possible to mutually transmit and receive information through a network such as the Internet. Note that, the communication between devices may be performed by either one of wireless communication and wired communication or a combination thereof.

### <Hardware Configuration of Device>

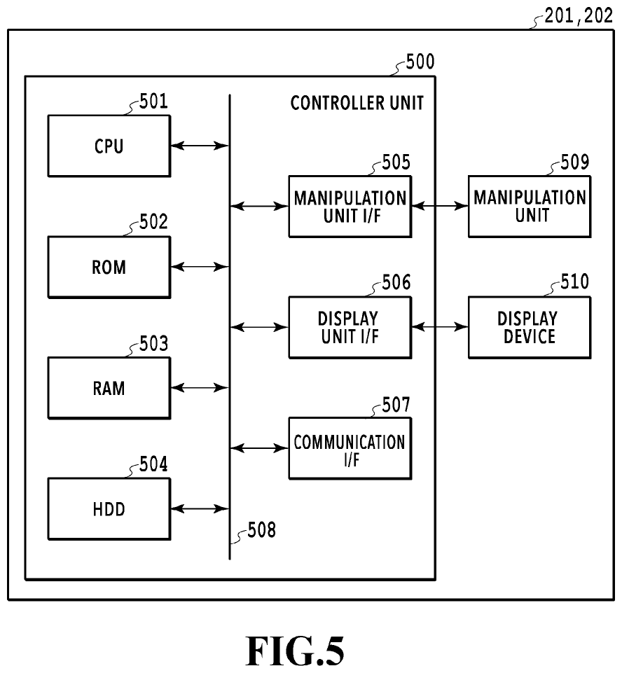

Subsequently, a hardware configuration example of the above-described devices is described with reference to a drawing. FIG. 5 is a diagram illustrating a hardware configuration example of the information processing apparatus 201 and the user terminal 202. The devices have a common hardware configuration that includes a controller unit 500, a manipulation unit 509, and a display device 510.

The controller unit 500 includes a CPU 501, a ROM 502, a RAM 503, an HDD 504, a manipulation unit interface (UF) 505, a display unit OF 506, and a communication OF 507. Note that, those are connected to each other through a system bus 508.

The central processing unit (CPU) 501 controls operations of the ROM 502, the RAM 503, the HDD 504, the manipulation unit OF 505, the display unit OF 506, and the communication I/F 507 through the system bus 508. The CPU 501 activates an operating system (OS) by a boot program stored in the read only memory (ROM) 502. The CPU 501 executes, for example, an application program stored in the hard disk drive (HDD) 504 on the activated OS. Various types of processing of each device are implemented with the CPU 501 executing the application program. The random access memory (RAM) 503 is used as a temporal storage region such as a main memory and a working area of the CPU 501. The HDD 504 stores the application program and the like as described above. Additionally, the CPU 501 may be formed of a single processor or may be formed of multiple processors.

The manipulation unit I/F 505 is an interface for the manipulation unit 509. The manipulation unit I/F 505 transmits information inputted from the manipulation unit 509 by the user to the CPU 501. The manipulation unit 509 includes, for example, equipment that can receive manipulation by the user such as a mouse, a keyboard, and a touch panel. The display unit I/F 506 is an interface for the display device 510. The display unit I/F 506 outputs, for example, image data to be displayed on the display device 510 to the display device 510. The display device 510 includes a display such as a liquid crystal display.

The communication I/F 507 is, for example, an interface for establishing communication such as Ethernet (registered trademark). The communication I/F 507 is connected to a transmission cable and includes a connector and the like to receive the transmission cable. The communication I/F 507 inputs and outputs information to and from an external device through the transmission cable. Note that, the communication I/F 507 may be, for example, a circuit that establishes wireless communication such as a baseband circuit or an RF circuit or an antenna. Additionally, the controller unit 500 also can perform control to display an image on the external display device 510 connected through the cable or the network. In this case, the controller unit 500 implements display control by outputting display data onto the external display device 510. Note that, the configuration in FIG. 5 is an example, and a part thereof may be omitted, a not illustrated configuration may be added, and moreover an illustrated configuration may be combined. For example, the information processing apparatus 201 may not include the display device 510.

Although the hardware configuration of the information processing apparatus 201 and the user terminal 202 is described above with reference to FIG. 5, any of the constituents illustrated in FIG. 5 are not essential constituents. Additionally, although the controller unit 500 is described that it includes the CPU 501 in the above description, it is not necessarily limited thereto. For example, instead of or in addition to the CPU 501 the controller unit 500 may include the hardware described below. That is, the controller unit 500 may include hardware such as an application specific integrated circuit (ASIC), a digital signal processor (DSP), or a field programmable gate array (FPGA). The hardware such as the ASIC, the DSP, or the FPGA may perform a part of or all the processing performed by the CPU 501.

### <Functional Configuration of Information Processing Apparatus>

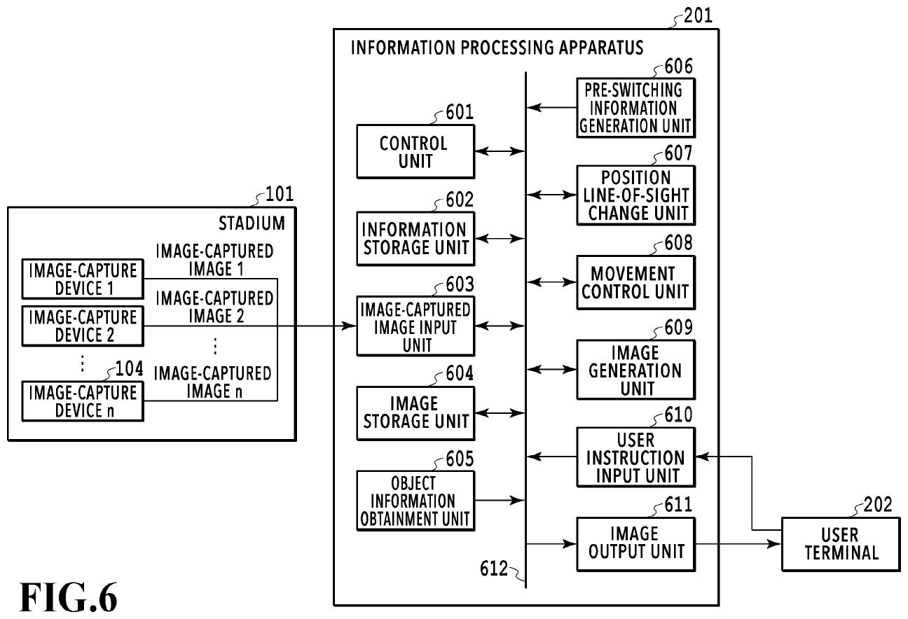

FIG. 6 is a diagram illustrating a functional configuration example of the information processing apparatus 201. Note that, each function illustrated in FIG. 6 is implemented with the CPU 501 of the information processing apparatus 201 reading various programs stored in the ROM 502 and executing control of each unit, for example. Each function unit illustrated in FIG. 6 may assume a part of or all the processing executed by another function unit. Additionally, a part of or all the configuration illustrated in FIG. 6 may be implemented by dedicated hardware such as an ASIC and an FPGA, for example.

As illustrated in FIG. 6, the information processing apparatus 201 includes a control unit 601, an information storage unit 602, an image-captured image input unit 603, an image storage unit 604, an object information obtainment unit 605, a pre-switching information generation unit 606, a position line-of-sight change unit 607, a movement control unit 608, and an image generation unit 609. The information processing apparatus 201 additionally includes a user instruction input unit 610 and an image output unit 611. Additionally, those function units are connected to each other by an internal bus 612 and can transmit and receive data to and from each other under control of the control unit 601.

The control unit 601 controls an operation of overall the information processing apparatus 201 according to a computer program stored in the information storage unit 602. The information storage unit 602 includes a non-volatile storage device such as a hard disk. The information storage unit 602 stores the computer program and the like to control the operation of overall the information processing apparatus 201.

The image-captured image input unit 603 obtains the image-captured images obtained by image-capturing by the multiple image-capture devices 104 disposed in the stadium 101 at a predetermined frame rate and outputs the image-captured images to the image storage unit 604. For example, an image-captured image 1, an image-captured image 2, . . . , an image-captured image n obtained by image-capturing by an image-capture device 1, an image-capture device 2, . . . , an image-capture device n, respectively, are obtained at a predetermined frame rate and outputted to the image storage unit 604. For example, the predetermined frame rate is a frame rate of 60 frames/second; however, it is not limited thereto. Note that, the image-captured image input unit 603 obtains the image-captured image from the image-capture device 104 by a wired or wireless communication module or an image transmission module such as an SDI.

The image storage unit 604 is, for example, a high-capacity storage device such as a magnetic disk, an optical disk, and a semiconductor memory. The image storage unit 604 stores the image-captured images obtained by the image-captured image input unit 603 and a virtual viewpoint image group generated based on the image-captured images. Note that, the image storage unit 604 may be provided physically outside the information processing apparatus 201. Additionally, the image-captured images stored in the image storage unit 604 and the virtual viewpoint image group generated based on the image-captured images are stored as a material exchange format (MXF) or the like as an image format, for example. In addition, the image-captured images stored in the image storage unit 604 and the virtual viewpoint image group generated based on the image-captured images are compressed as an MPEG2 format or the like, for example. Note that, the format of data is not necessarily limited thereto. An arbitrary image format and data compression method may be used. Additionally, compression coding may not be performed.

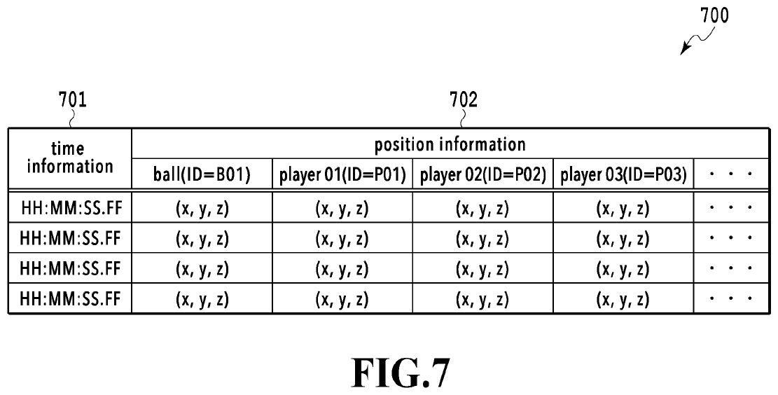

The object information obtainment unit 605 obtains object information from a not-illustrated external device. The external device may use a tracking system that collects GPS information attached to a player and a ball, for example. FIG. 7 illustrates a configuration example of the object information. Object information 700 includes, for example, time information 701 and position information 702. The time information 701 is formed of HH(hour):MM(minute):SS(second).FF(frame). The position information 702 is information corresponding to the time indicated by the time information 701 and is information indicating the position of the object (for example, a ball, a player, and a referee) by using the three-dimensional orthogonal coordinate. An object name is formed of an arbitrary name and the object identification ID. The object identification ID is formed of an alphabet and a number and is an identification symbol allocated to distinguish each object. The object information is periodically transmitted from an external database every second, for example; however, it is not limited thereto. For example, the object information may be transmitted from the external database at a constant interval or may be temporarily stored in the image storage unit 604 through the object information obtainment unit 605. Additionally, although the tracking system in the above description identifies the position of the object by using the GPS information, it is not limited thereto. For example, the position of the object may be identified by using a technique such as visual hull. The object information may include body information on each object in addition to the above-described configuration. The body information may include information indicating the size of a body height obtained by measuring the body height of the object, or in addition, information indicating a body weight and information indicating a chest circumference obtained by measuring the body weight, the chest circumference, and the like may be additionally included.

In a case of receiving the switching request (switching instruction) from the user terminal 202, the pre-switching information generation unit 606 generates pre-switching information (switching information) based on the position and the line-of-sight direction of the virtual viewpoint before movement and the position of the object captured from the virtual viewpoint (hereinafter, called a pre-movement main object in some cases). In a case where the user instruction received by the user instruction input unit 610 includes an instruction to switch from the first virtual viewpoint to the second virtual viewpoint, the pre-switching information generation unit 606 generates the switching information indicating a positional relationship between the first virtual viewpoint and the first object.

The pre-switching information includes an angle, a distance, a height, and a line-of-sight direction. The angle is an angle formed between a traveling direction of the pre-movement main object and a direction in which the virtual viewpoint is positioned in a view from the pre-movement main object. The distance is a distance between the pre-movement main object and the virtual viewpoint. The height is a height of the virtual viewpoint from ground. The line-of-sight direction is a line-of-sight direction from the virtual viewpoint (pan, tilt, and roll).

### <Processing to Switch Virtual Viewpoint>

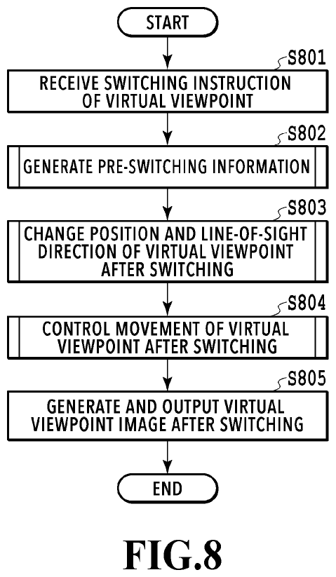

Processing to switch the virtual viewpoint executed by the information processing apparatus 201 is described with reference to a drawing. FIG. 8 is a flowchart illustrating a flow of the processing to switch the virtual viewpoint executed by the information processing apparatus. Note that, a sign “S” in the description of the flowchart represents a step. In this regard, the same applies to the descriptions of the following flowcharts.

In S801, the information processing apparatus 201 (the user instruction input unit 610) receives the switching request (switching instruction) to switch the position of the virtual viewpoint by manipulation by the user. The switching instruction is transmitted to the pre-switching information generation unit 606.

### <Switching of Position of Virtual Viewpoint>

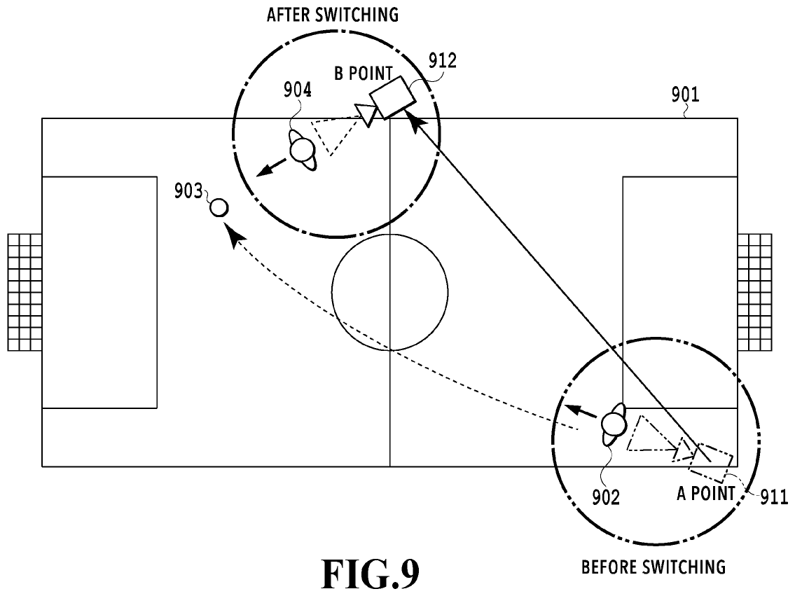

FIG. 9 is a diagram describing switching of the position of the virtual viewpoint. FIG. 9 illustrates a scene in which a player 902 (first object) near a penalty kick area in the own side in a field 901 makes a pass to a player 904 (second object) in the opposing side. Before the position of the virtual viewpoint is switched, a virtual camera 911 before switching is arranged at an A point to capture the player 902 (first object) moving toward the center circle from behind. Assuming that there is received manipulation by the user to switch the position of the virtual camera to capture the player 904 (second object) moving toward a soccer ball 903 to receive the soccer ball 903 kicked from the player 902 to the vicinity of the penalty kick area in the opposing side. In this case, the position of a virtual camera 912 is switched as described below. That is, after the position of the virtual viewpoint is switched, the virtual camera 912 after switching is arranged at a B point such that a positional relationship between the virtual camera 912 and the player 904 (second object) is the same as a positional relationship between the virtual camera 911 before switching and the player 902.

In S802, once receiving the switching instruction transmitted from the user instruction input unit 610, the information processing apparatus 201 (the pre-switching information generation unit 606) generates the pre-switching information. Details of processing to generate the pre-switching information are described below. The pre-switching information is transmitted to the position line-of-sight change unit 607.

In S803, the information processing apparatus 201 (the position line-of-sight change unit 607) changes the position of the virtual viewpoint after switching and the line-of-sight direction from the virtual viewpoint after switching. Details of the processing to change the position of the virtual viewpoint after switching and the line-of-sight direction from the virtual viewpoint after switching are described below. Post-switching information indicating the position of the virtual viewpoint after switching and the line-of-sight direction from the virtual viewpoint after switching is transmitted to the movement control unit 608.

In S804, the information processing apparatus 201 (the movement control unit 608) executes processing to control movement of the virtual viewpoint after switching. Details of the processing to control movement of the virtual viewpoint after switching are described below.

In S805, the information processing apparatus 201 (the image generation unit 609) receives a camera path and generates the virtual viewpoint image according to the received camera path. The generated virtual viewpoint image is transmitted to the image output unit 611. The information processing apparatus 201 (the image output unit 611) then outputs the virtual viewpoint image transmitted from the image generation unit 609 to the user terminal 202 and displays the virtual viewpoint image corresponding to the virtual viewpoint after switching on the user terminal 202.

### <Virtual Viewpoint Images Before and After Switching>

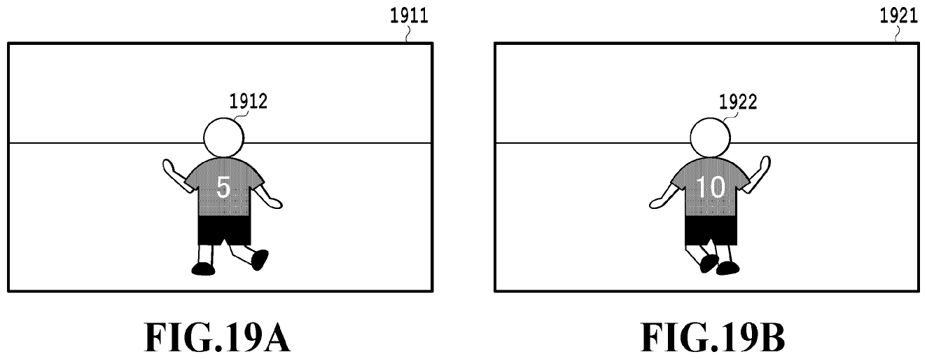

FIGS. 19A and 19B are diagrams describing virtual viewpoint image examples before and after switching displayed on the user terminal. FIG. 19A illustrates a virtual viewpoint image example before switching, and FIG. 19B illustrates a virtual viewpoint image example after switching. Note that, the virtual viewpoint image before switching corresponds to an image captured by the virtual camera 911 arranged at the A point illustrated in FIG. 9, and the virtual viewpoint image after switching corresponds to an image captured by the virtual camera 912 arranged at the B point illustrated in FIG. 9.

A virtual viewpoint image 1911 before switching is an image of a back shot of a player 1912 (first interest object) in the center. Additionally, a virtual viewpoint image 1921 after switching is an image of a back shot of a player 1922 (second interest object) in the center.

That is, the user terminal 202 displays the virtual viewpoint image after switching having a composition similar to that of the virtual viewpoint image before switching.

### <Processing to Generate Pre-Switching Information>

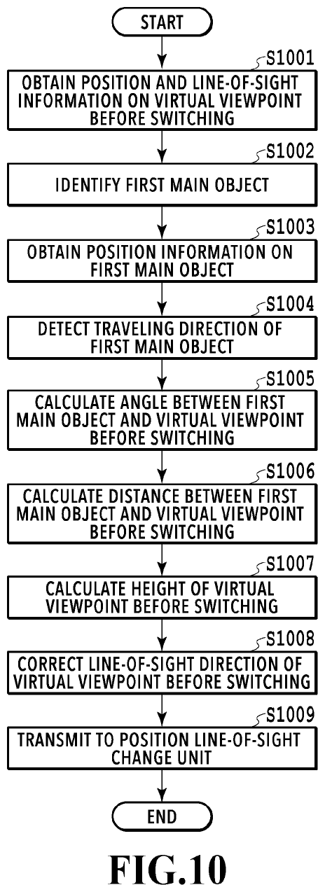

FIG. 10 is a flowchart illustrating a flow of processing executed by the information processing apparatus 201 (the pre-switching information generation unit 606).

In S1001, the pre-switching information generation unit 606 obtains from the user terminal 202 the virtual viewpoint manipulation information including the information indicating the position of the virtual viewpoint immediately before the switching manipulation by the user is performed and the information indicating the line-of-sight direction from the virtual viewpoint. The virtual viewpoint manipulation information is the information received from the user terminal 202 at the time of receiving the switching request.

In S1002, the pre-switching information generation unit 606 identifies the pre-movement main object (the first main object immediately before the switching manipulation) based on the position of the virtual viewpoint and the line-of-sight direction from the virtual viewpoint indicated by the virtual viewpoint manipulation information obtained in S1001. For example, the pre-switching information generation unit 606 may obtain the line-of-sight direction from the virtual viewpoint based on the position and the line-of-sight of the virtual viewpoint and may identify a player who is an object at a position overlapped with the line-of-sight direction as the pre-movement main object. In addition, an object nearest the line-of-sight direction out of multiple objects may be identified as the pre-movement main object. Note that, a method of identifying the main object (object) is not limited thereto, and a different method may be applicable.

In S1003, the pre-switching information generation unit 606 obtains the position information on the pre-movement main object identified in S1002. The pre-switching information generation unit 606 obtains the position information on the pre-movement main object identified in S1002 out of the position information on multiple objects obtained by the object information obtainment unit 605. In this process, the pre-switching information generation unit 606 obtains the position information in a predetermined time from receiving the switching request (switching instruction) to the past. The predetermined time in S1003 is several seconds, for example, and may be the time that allows for identification of the traveling direction of the pre-movement main object in S1004, which is processing following the processing in S1003.

In S1004, the pre-switching information generation unit 606 detects the traveling direction of the pre-movement main object. Based on the position information in the predetermined time obtained in S1003, the pre-switching information generation unit 606 detects the traveling direction from trajectory of transition of the position of the pre-movement main object. Note that, although S1004 is described by using a method of detecting the traveling direction of the main object from the trajectory of transition of the position, it is not limited thereto. For example, the face of the main object may be identified by using a face recognition technique, and a direction in which the face is facing may be detected as front. Additionally, a uniform number may be identified by using an image analysis technique, and a direction in which there is the uniform number may be detected as behind. Any method may be applicable as long as a specific direction of either front or behind can be detected based on the main object, and the traveling direction of the pre-movement main object can be identified based on the detection result.

In S1005, the pre-switching information generation unit 606 calculates an angle formed between the traveling direction of the pre-movement main object detected in S1004 and a direction in which the virtual viewpoint is positioned in a view from the pre-movement main object (hereinafter, called a virtual viewpoint direction in some cases). The virtual viewpoint direction is calculated based on the position of the virtual viewpoint included in the virtual viewpoint manipulation information obtained in S1001 and the position of the pre-movement main object included in the position information on the object obtained in S1003. The object information used in this process is only the object information at the time of receiving the switching request.

### <Method of Calculating Angle Formed Between Traveling Direction and Virtual Viewpoint Direction>

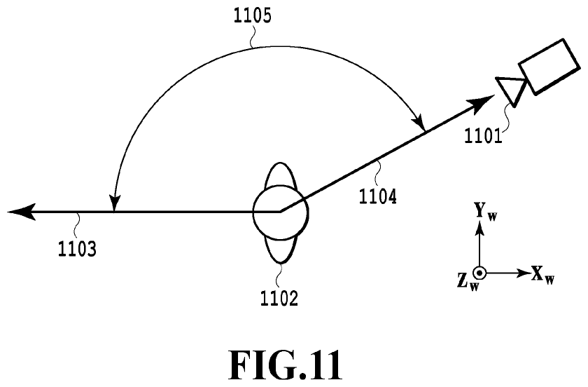

FIG. 11 is a schematic view describing a method of calculating an angle formed between the traveling direction of the first main object and the virtual viewpoint direction before switching. A virtual viewpoint 1101 before switching is arranged to image-capture a main object 1102 by targeting from obliquely behind the object. A traveling direction 1103 indicates a direction in which the main object 1102 travels. A virtual viewpoint direction 1104 is a direction in which the virtual viewpoint 1101 viewed from the main object 1102 is positioned. An angle 1105 is an angle formed between the traveling direction 1103 and the virtual viewpoint direction 1104.

The angle formed between the traveling direction 1103 and the virtual viewpoint direction 1104 is calculated by using Expression (1) indicated below, for example. For example, the traveling direction 1103 is a vector a, and the virtual viewpoint direction 1104 is a vector b. In Expression (1), the vector a is (a1, a2, a3), the vector b is (b1, b2, b3), and an angle of a corner formed by the vector a and the vector b is θ (0≤θ≤180).

$$cos θ = \frac{\vec{α} \cdot \vec{b}}{\vert \vec{α} \vert \vert \vec{b} \vert} = \frac{{α}_{1} {b}_{1} + {α}_{2} {b}_{2} + {α}_{3} {b}_{3}}{\sqrt{{α}_{1}^{2} + {α}_{2}^{2} + {α}_{3}^{2}} \sqrt{{b}_{1}^{2} + {b}_{2}^{2} + {b}_{3}^{2}}} \qquad ( 1 )$$

In S1006, the pre-switching information generation unit 606 calculates the distance between the pre-movement main object and the virtual viewpoint. Based on the position of the virtual viewpoint indicated by the virtual viewpoint manipulation information obtained in S1001 and the position of the first interest object indicated by the position information obtained in S1003, the pre-switching information generation unit 606 calculates the distance between the pre-movement main object and the virtual viewpoint before switching. The position of the pre-movement main object used in this case is the position at the time of receiving the switching request (switching instruction).

In S1007, the pre-switching information generation unit 606 calculates the height of the virtual viewpoint before switching. The pre-switching information generation unit 606 extracts a value in a z direction from the position information included in the virtual viewpoint manipulation information obtained in S1001. The pre-switching information generation unit 606 sets the extracted value in the z direction as the height of the virtual viewpoint before switching.

In S1008, the pre-switching information generation unit 606 corrects the line-of-sight direction from the virtual viewpoint before switching. That is, the pre-switching information generation unit 606 corrects an angle in a pan direction included in the virtual viewpoint manipulation information obtained in S1001. The pre-switching information generation unit 606 changes a reference line (line at an angle of 0 degree) for measuring the angle in the pan direction to be directed into the direction of the pre-movement main object. Thereafter, an angle is obtained from the changed reference line and is replaced as the angle in the pan direction. Note that, as angles in a tilt direction and a roll direction, angles included in the virtual viewpoint manipulation information obtained in S1001 are used. For this reason, the correction processing is not executed for the angles in the tilt direction and the roll direction.

### <Method of Correcting Angle in Pan Direction>

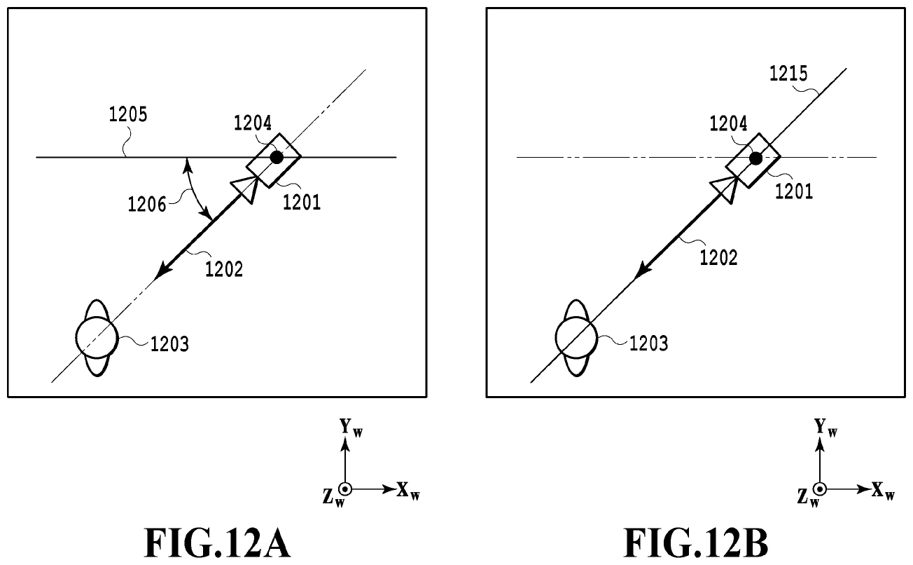

FIGS. 12A and 12B are schematic views describing a method of correcting the angle in the pan direction of the virtual viewpoint before switching. FIG. 12A illustrates a state before correcting the angle in the pan direction, and FIG. 12B illustrates a state after correcting the angle in the pan direction. A virtual viewpoint 1201 is arranged at a position to image-capture by directing a line-of-sight direction 1202 to a main object 1203 from the virtual viewpoint 1201. The line-of-sight direction 1202 can be moved in the right and left direction about a pan axis 1204 as the center of the axis.

As illustrated in FIG. 12A, before correction, an angle 1206 is the same angle as the angle in the pan direction included in the virtual viewpoint manipulation information obtained in S1001. The angle 1206 is an angle formed between a reference line 1205 and the line-of-sight direction 1202. The reference line 1205 is in a state of pointing to a direction other than the main object 1203 and, for example, points to the center of the center circle in the field. In a case where the reference line is different from the object (first main object), the pre-switching information generation unit 606 changes the reference line 1205 before correction to a reference line 1215, which is a line connecting the virtual viewpoint 1201 and the main object (first main object) 1203 as illustrated in FIG. 12B. The reference line 1215 after change (after correction) is a straight line connecting the pan axis 1204 and the main object 1203. The pre-switching information generation unit 606 obtains an angle formed between the reference line 1215 after correction and the line-of-sight direction 1202 and corrects the obtained angle as the angle in the pan direction. Note that, in the example illustrated in FIG. 12B, since the reference line 1215 after correction and the line-of-sight direction 1202 coincide with each other, the angle in the pan direction is 0 degree.

In S1009, the pre-switching information generation unit 606 transmits the pre-switching information storing the information, which is the angle, the distance, the height, and the line-of-sight direction respectively obtained from the processing from S1005 to S1008, to the position line-of-sight change unit 607.

Based on the pre-switching information received from the pre-switching information generation unit 606, the position line-of-sight change unit 607 changes the position of the virtual viewpoint after movement (after switching) and the line-of-sight direction from the virtual viewpoint after movement (after switching). That is, based on the switching information, the position line-of-sight change unit 607 changes the positional relationship between the second virtual viewpoint and the second object to be similar to the positional relationship between the first virtual viewpoint and the first object.

### <Processing to Change Position Line-of-Sight Direction of Virtual Viewpoint>

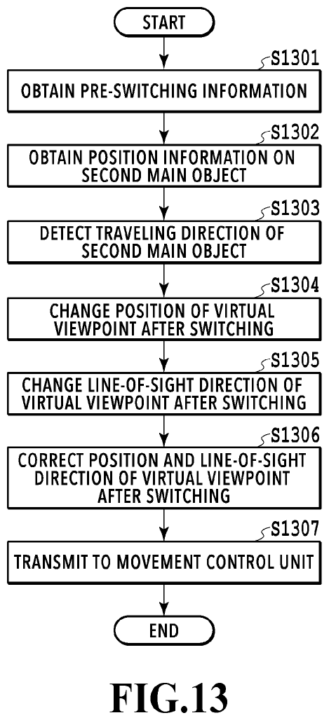

FIG. 13 is a flowchart illustrating a flow of processing executed by the information processing apparatus 201 (the position line-of-sight change unit 607). The flowchart starts execution at the time of receiving the pre-switching information. With the execution of the processing, the position of the virtual viewpoint and the line-of-sight direction from the virtual viewpoint after switching are changed.

In S1301, the position line-of-sight change unit 607 obtains the pre-switching information generated in S802 from the pre-switching information generation unit 606. The pre-switching information includes, for example, information indicating the angle, the distance, the height, and the line-of-sight direction of the virtual viewpoint before movement.

In S1302, the position line-of-sight change unit 607 obtains the position information on the object captured by the virtual viewpoint after movement (hereinafter, called a post-movement main object in some cases). The position line-of-sight change unit 607 obtains the object identification information associated with the switching request received from the user terminal 202. The position line-of-sight change unit 607 obtains the position information on the post-movement main object from the object information obtainment unit 605 by using the object identification ID included in the object identification information. In this process, the position line-of-sight change unit 607 obtains the position information in a predetermined time from receiving the switching request from the user terminal 202 to the past. The predetermined time in S1302 is, for example, several seconds, and may be the time that allows for identification of the traveling direction of the post-movement main object in S1303, which is processing following the processing in S1302.

In S1303, the position line-of-sight change unit 607 detects the traveling direction of the post-movement main object. Based on the position information in the predetermined time obtained in S1302, the position line-of-sight change unit 607 detects the traveling direction from trajectory of transition of the position of the post-movement main object. Note that, although an aspect in which the traveling direction of the main object is detected is described in S1303, it is not limited thereto. For example, the face of the main object may be identified by using the face recognition technique, and a direction in which the face is facing may be detected as front. Based on the detection result, the traveling direction of the post-movement main object may be detected. Additionally, a uniform number may be identified by using the image analysis technique, and a direction in which there is the uniform number may be detected as behind. Based on the detection result, the traveling direction of the post-movement main object may be detected. Any method may be applicable as long as a specific direction of either front or behind can be detected based on the main object. Note that, the method of detecting the traveling direction in S1303 is the same method as the method of detecting the traveling direction in S1004 described above.

In S1304, the position line-of-sight change unit 607 changes the position of the virtual viewpoint after movement. Based on the traveling direction detected in S1303, the position line-of-sight change unit 607 applies the angle, the distance, and the height included in the pre-switching information obtained in S1301 and changes the position of the virtual viewpoint after movement.

### <Method of Changing Position of Virtual Viewpoint After Movement>

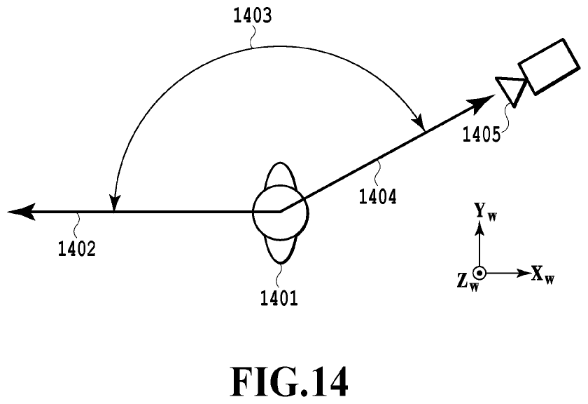

FIG. 14 is a schematic view describing a method of changing the position of the virtual viewpoint after movement. A main object (second main object) 1401 indicates the post-movement main object. A movement direction 1402 indicates a direction in which the main object 1401 detected in S1303 moves (travels).

Based on the movement direction 1402, the position line-of-sight change unit 607 changes a line-of-sight direction 1404 from the virtual viewpoint by applying an angle 1403 included in the pre-switching information. Additionally, the position line-of-sight change unit 607 changes the position of a virtual viewpoint 1405 by applying the distance and the height included in the pre-switching information from the main object 1401 to the direction 1404 of the virtual viewpoint.

In S1305, the position line-of-sight change unit 607 changes the line-of-sight direction from the virtual viewpoint after movement. The position line-of-sight change unit 607 sets the direction 1404 of the virtual viewpoint illustrated in FIG. 14 as the reference line (line at an angle of 0 degree) for measuring the angle in the pan direction. The position line-of-sight change unit 607 changes the line-of-sight direction from the virtual viewpoint after movement by applying the line-of-sight direction included in the pre-switching information obtained in S1301 to the reference line.

In S1306, the position line-of-sight change unit 607 corrects the position of the virtual viewpoint after movement and the line-of-sight direction from the virtual viewpoint after movement that are changed in S1304 and S1305. The position line-of-sight change unit 607 obtains the body information included in the object information from the object information obtainment unit 605. The position line-of-sight change unit 607 obtains the body information on the pre-movement main object and the body information on the post-movement main object and corrects the position and the line-of-sight direction of the virtual viewpoint after movement based on the difference between the body information.

### <Method of Correcting Position Line-of-Sight Direction of Virtual Viewpoint After Movement>

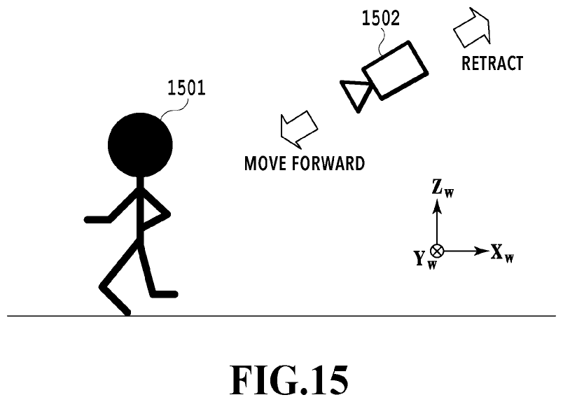

FIG. 15 is a schematic view describing a method of correcting the position of the virtual viewpoint and the line-of-sight direction from the virtual viewpoint after movement. A main object 1501 indicates the post-movement main object after switching the virtual viewpoint from the position in which the first object is captured to the position in which the second object is captured. A virtual viewpoint 1502 indicates the virtual viewpoint after movement indicating the position of the virtual viewpoint after switching changed by the processing in S1304 and the line-of-sight direction from the virtual viewpoint after switching changed by the processing in S1305.

For example, in a case where the body height of the main object 1501 (second object) is 180 centimeters and greater than the body height of the pre-movement main object (first object), which is 160 centimeters, there is a possibility that a state described below occurs. That is, if the position of the virtual viewpoint 1502 after switching is changed with respect to the second object so as to obtain the same positional relationship as the positional relationship between the virtual viewpoint before switching and the first object, there is a possibility that the main object 1501 is cut off from the visual field boundary of the virtual viewpoint 1502. In this case, the position line-of-sight change unit 607 changes the position of the virtual viewpoint 1502 to be away and retracted from the main object 1501 such that the main object 1501 is within the visual field boundary of the virtual viewpoint 1502.

On the other hand, in a case where the body height of the main object 1501 is smaller than the body height of the pre-movement main object, there is a possibility that a state described below occurs. That is, if the position of the virtual viewpoint 1502 after switching is changed with respect to the second object so as to obtain the same positional relationship as the positional relationship between the virtual viewpoint before switching and the first object, there is a possibility that the main object 1501 is at a position far from the virtual viewpoint 1502 and appears small. In this case, the position line-of-sight change unit 607 changes the position of the virtual viewpoint 1502 after switching with respect to the second object to move forward so as to bring the virtual viewpoint 1502 close to the main object 1501.

### <Correction of Position and Line-of-Sight Direction of Virtual Viewpoint After Switching>

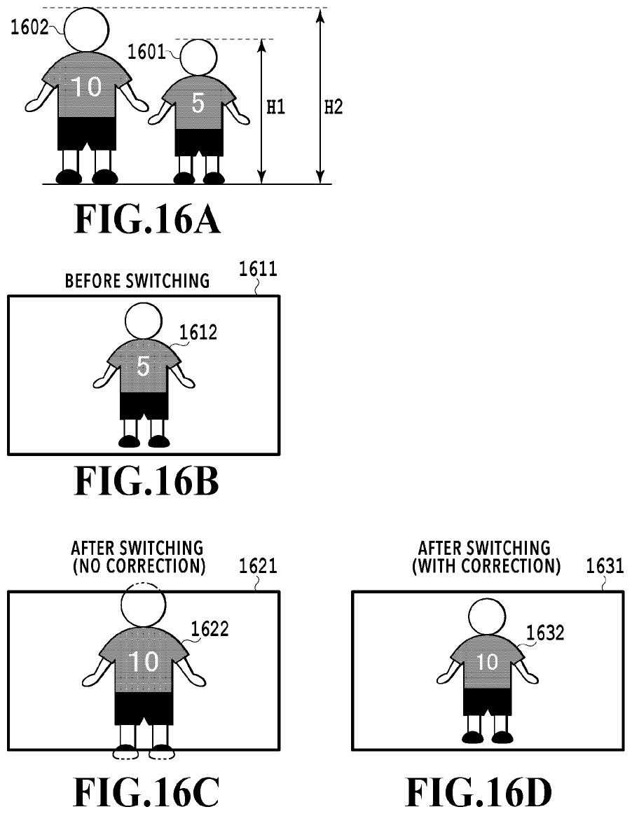

FIGS. 16A to 16D are diagrams describing correction of the position of the virtual viewpoint after switching and the line-of-sight direction from the virtual viewpoint after switching. FIG. 16A illustrates the body heights of the first and second main objects, and FIG. 16B illustrates a virtual viewpoint image example before switching. FIG. 16C illustrates a virtual viewpoint image example after switching in a case of not using the body information on the main object, and FIG. 16D illustrates a virtual viewpoint image example after switching in a case of using the body information on the main object.

As illustrated in FIG. 16A, the body height of a player 1601 (first main object), who has a uniform number of 5 and is captured by the virtual camera before switching, is H1. Additionally, the body height of a player 1602 (second main object), who has a uniform number of 10 and is captured by the virtual camera after switching, is H2 higher than the body height of the player 1601.

The virtual viewpoint image captured by the virtual camera before switching is an image described below. That is, as illustrated in FIG. 16B, a virtual viewpoint image 1611 captured by the virtual camera before switching is an image showing a whole body of a player 1612 (first main object) in the center.

In a case where the body information on the player 1601 (first main object) and the player 1602 (second main object) is not used, and the position and the orientation (line-of-sight direction) of the virtual camera before switching are not corrected, the virtual viewpoint image captured by the virtual camera after switching is an image as described below. That is, as illustrated in FIG. 16C, although a virtual viewpoint image 1621 captured by the virtual camera after switching is an image showing a player 1622 (second main object) in the center, it is an image in a state where an upper side of the head and a lower side of the leg of the player 1622 are cut off.

On the other hand, in a case where the position and the orientation (line-of-sight direction) of the virtual camera after switching are corrected by using the body information on the player 1601 (first main object) and the player 1602 (second main object), the virtual viewpoint image by the virtual camera after switching is an image described below. That is, as illustrated in FIG. 16D, a virtual viewpoint image 1631 captured by the virtual camera after switching is an image showing a whole body of a player 1632 (second main object) in the center.

Thus, it is possible to make the composition of the virtual viewpoint image after switching almost the same as the composition of the virtual viewpoint image before switching by correcting the position and the orientation (line-of-sight direction) of the virtual camera by using the body height information on the first and second objects.

Referring back to FIG. 13. In S1307, the position line-of-sight change unit 607 transmits the information on the position of the virtual viewpoint after movement and the line-of-sight direction from the virtual viewpoint after movement that are corrected in S1306 (post-switching information) to the movement control unit 608.

The movement control unit 608 arranges the virtual viewpoint after movement based on the position and the line-of-sight direction changed by the position line-of-sight change unit 607 by using the post-switching information received from the position line-of-sight change unit 607 and automatically controls the virtual viewpoint after arrangement.

### <Processing to Control Movement of Virtual Viewpoint>

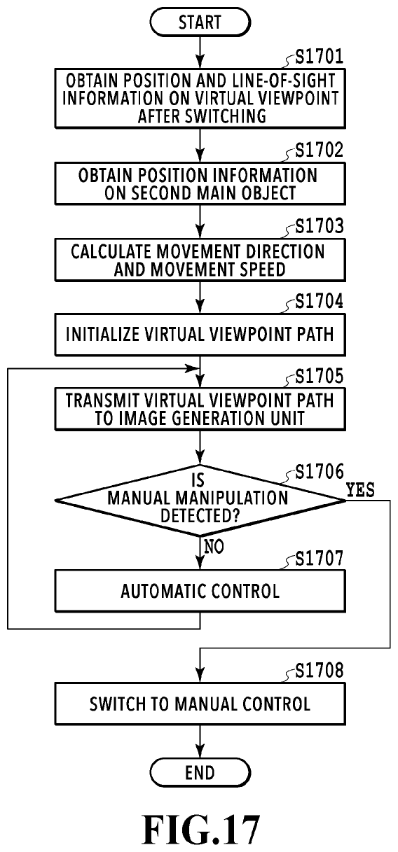

FIG. 17 is a flowchart illustrating a flow of processing executed by the information processing apparatus 201 (the movement control unit 608). The flowchart starts execution at the time of receiving the position and line-of-sight information after movement from the position line-of-sight change unit 607.

In S1701, the movement control unit 608 obtains the post-switching information generated in S803 from the position line-of-sight change unit 607. The post-switching information includes, for example, information indicating the position of the virtual viewpoint after movement and the line-of-sight direction from the virtual viewpoint after movement.

In S1702, the movement control unit 608 obtains the position information on the post-movement main object. The movement control unit 608 obtains the object identification information associated with the switching request (switching instruction) received from the user terminal 202. The movement control unit 608 obtains the position information on the post-movement main object from the object information obtainment unit 605 by using the object identification ID included in the object identification information. In this process, the movement control unit 608 obtains the position information in a predetermined time from receiving the switching request from the user terminal 202 to the past. The predetermined time in S1702 is, for example, several seconds, and may be the time that allows for identification of the movement direction (traveling direction) of the post-movement main object in S1703, which is processing following the processing in S1702.

In S1703, the movement control unit 608 calculates a movement direction and a movement speed of the post-movement main object. The movement direction can be detected from trajectory of transition of the position of the post-movement main object based on the position information in the predetermined time obtained in S1702. The movement direction may include, for example, a linear traveling direction, an arc-linear traveling direction, and the like. The movement speed can be calculated by dividing the movement distance of the post-movement main object by the predetermined time.

In S1704, the movement control unit 608 sets the position of the virtual viewpoint after movement and the line-of-sight direction from the virtual viewpoint after movement that are obtained in S1701 as an initial value of the camera path (virtual viewpoint path).

In S1705, the movement control unit 608 transmits the camera path to the image generation unit 609.

In S1706, the movement control unit 608 determines whether the user performs manual manipulation of the virtual viewpoint from the user terminal 202 through the user instruction input unit 610. As a method of detecting the manual manipulation, for example, it may be determined that the manual manipulation is detected in a case where manipulation by the user on the manipulation screen 303 is detected. If a determination result that the manual manipulation is detected is obtained (YES in S1706), the processing proceeds to S1708 so as to end the automatic control of the virtual viewpoint. If a determination result that the manual manipulation is not detected (NO in S1706), the processing proceeds to S1707 so as to continue the automatic control of the virtual viewpoint. Note that, the determination processing in S1706 is executed by the unit of frame, for example.

In S1707, the movement control unit 608 automatically controls the virtual viewpoint after movement. The movement control unit 608 applies the movement direction and the movement speed calculated in S1703 to the camera path initialized in S1704 to update the camera path to a camera path including the moved position of the virtual viewpoint. The updated camera path is temporarily held and used in the next processing. After the processing in S1707 is completed, the processing returns to S1705.

In S1708, the movement control unit 608 switches the control of the virtual viewpoint after movement from the automatic control to the manual control. After switching, the movement control unit 608 continuously receives the virtual viewpoint manipulation information through the user instruction input unit 610 and transmits the virtual viewpoint manipulation information to the image generation unit 609 as the camera path.

### <Transition of Virtual Viewpoint by Automatic Control>

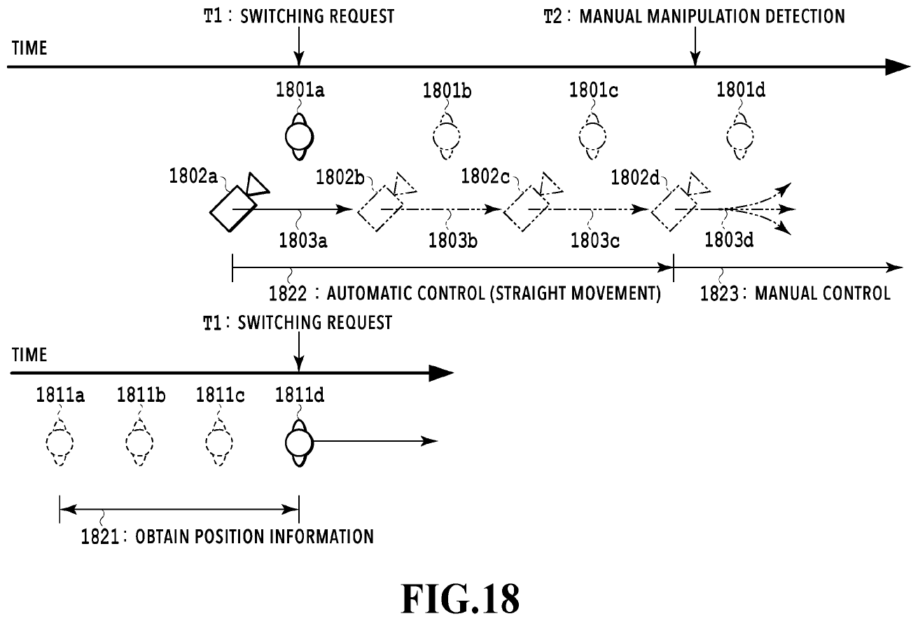

FIG. 18 is a schematic view describing transition of the virtual viewpoint (virtual camera) by the automatic control. Positions 1801a to 1801d of the main object are positions of the post-movement main object. Positions of 1802a to 1802d of the virtual viewpoint are positions of the virtual viewpoint after movement (after switching). Movement directions 1803a to 1803d are the movement direction and the movement speed calculated in S1703. Note that, the movement directions 1803a to 1803c are in the same direction and at the same speed. The movement direction 1803d is different in the direction and the speed from a case of the movement directions 1803a to 1803c.

FIG. 18 illustrates that the positions of the second main object and the virtual viewpoint after switching are moved from the positions 1801a and 1802a to the positions 1801b and 1802b once the processing in S1707 is performed. Additionally, there is illustrated that the positions of the second main object and the virtual viewpoint after switching are moved from the positions 1801b and 1802b to the positions 1801c and 1802c once the processing in S1707 is performed. Moreover, there is illustrated that the positions of the second main object and the virtual viewpoint after switching are moved from the positions 1801c and 1802c to the positions 1801d and 1802d once the processing in S1707 is performed. That is, there is illustrated a situation in which the positions of the second main object and the virtual viewpoint after switching are sequentially moved from the positions 1801a and 1802a to the positions 1801d and 1802d every time the processing in S1707 is performed.

The above-described position 1802a of the virtual viewpoint is the position of the virtual viewpoint and the line-of-sight direction from the virtual viewpoint indicated by the camera path initialized in S1704 and is a start point of the virtual viewpoint after movement (after switching). The position of the virtual viewpoint is moved to the position 1802b of the virtual viewpoint by applying the movement direction 1803a to the position 1802a of the virtual viewpoint. Next, the position of the virtual viewpoint is moved to the position 1802c of the virtual viewpoint by applying the movement direction 1803b to the position 1802b of the virtual viewpoint. While repeating similar processing, the movement control unit 608 executes the automatic control to move the virtual viewpoint.

Note that, the automatic movement control of the second main object is performed based on the obtained position information on the first main object from a position 1811a to a position 1811d by way of a position 1811b and the position 1811c of the first main object.

That is, automatic control (straight movement) 1822 is applied to the virtual camera after switching that captures the second main object after receiving a switching request T1. Additionally, once receiving manual manipulation detection T2, manual control 1823 is applied to the virtual camera after switching that captures the second main object.

The image generation unit 609 generates the virtual viewpoint image (manipulation image) by using the camera path received from the movement control unit 608 and the multiple image-captured images stored in the image storage unit 604. It can also be said that the image generation unit 609 generates the virtual viewpoint image corresponding to the second virtual viewpoint that is changed in accordance with the positional relationship between the second virtual viewpoint and the second object that is changed by the position line-of-sight change unit 607. Additionally, the image generation unit 609 generates the virtual viewpoint image (bird's-eye image) by using the camera path of viewing the image-captured space from directly above and the multiple image-captured images stored in the image storage unit 604. The manipulation image is displayed on the manipulation screen in the user terminal. Additionally, the bird's-eye image is displayed on the switching screen in the user terminal.

The virtual viewpoint image is generated by using image-based rendering, for example. The image-based rendering is a rendering method to generate the virtual viewpoint image from images that are image-captured from multiple actual viewpoints without performing modeling (a process of creating the shape of an object by using a geometric figure). Note that, the virtual viewpoint image may be generated without the image-based rendering and, for example, the virtual viewpoint image may be generated by using model-based rendering (MBR). The above-described MBR is a method of generating the virtual viewpoint image by using a three-dimensional model generated based on the multiple image-captured images obtained by image-capturing the object from multiple directions. The above-described MBR uses, for example, a three-dimensional shape (model) of a target scene obtained by a method of restoring a three-dimensional shape such as the visual hull and multi-view-stereo (MVS) and generates a view of the scene from the virtual viewpoint as an image (virtual viewpoint image). Additionally, instead of the virtual viewpoint image, for example, the information processing apparatus 201 may generate information indicating a three-dimensional model such as three-dimensional shape data or information for generating the virtual viewpoint image such as an image for mapping the three-dimensional model indicated by the above information.

The user instruction input unit 610 receives a manipulation instruction and associated information associated with the manipulation instruction, which are a user instruction related to the virtual viewpoint for generating the virtual viewpoint image, from the user terminal 202. The user instruction input unit 610 receives, for example, the switching request (switching instruction) of the virtual viewpoint image or the object identification information associated with the switching request. The received switching instruction and associated information are transmitted to each processing unit of the information processing apparatus 201 such as the pre-switching information generation unit 606.

The image output unit 611 outputs the virtual viewpoint image generated by the image generation unit 609 to the user terminal 202.

As described above, according to the present embodiment, the position and the line-of-sight direction of the virtual viewpoint after switching are automatically set such that a view from the virtual viewpoint capturing the first main object before switching and a view from the virtual viewpoint capturing the second main object after switching are the same. That is, the position of the virtual viewpoint after switching and the line-of-sight direction from the virtual viewpoint after switching are automatically set such that the compositions of the virtual viewpoint images are the same between before and after switching of the position of the virtual viewpoint. Thus, the user can easily figure out the position of the virtual viewpoint after switching and the line-of-sight direction from the virtual viewpoint after switching in the virtual viewpoint image after switching without losing a sense of direction and can smoothly start manipulating the virtual viewpoint after switching.

Additionally, movement of the virtual viewpoint immediately after switching the position of the virtual viewpoint is supported by automatically controlling movement of the virtual viewpoint after switching so as to hold the positional relationship between the virtual viewpoint before switching and the first main object. Thus, there is no losing sight of the second main object after switching including that the second main object captured from the virtual viewpoint after switching moves out from the inside of the virtual viewpoint image after switching, and it is possible to smoothly start manipulating the virtual viewpoint after switching.

Moreover, it is also possible to apply the first main object captured from the virtual viewpoint before switching and the second main object captured from the virtual viewpoint after switching to the same aspect.

Although an aspect of performing switching of the virtual viewpoint, the automatic control of movement of the virtual viewpoint, and the manual control of the virtual viewpoint is described above, it is not limited thereto. For example, switching of the virtual viewpoint and the manual control of the virtual viewpoint may be performed. In this case, in order to make the compositions of the virtual viewpoint images before and after switching the same, direction information indicating directions of the first and second interest objects may be obtained instead of the movement information.

Although the descriptions are given assuming that the virtual viewpoint is switched to image-capture another object in the same image-capture space during the manual manipulation in the above-described embodiment, it is not limited thereto. For example, here is assumed a case where there are multiple virtual viewpoints, and different objects are image-captured therefrom, respectively. In this case, it is possible to apply the present embodiment even in a case of switching from the virtual viewpoint displayed on the user terminal to another virtual viewpoint. Also in this case, similarly, it is possible to automatically set the position of the virtual viewpoint after switching and the line-of-sight direction from the virtual viewpoint after switching so as to make a view from the virtual viewpoint capturing the main object before switching and a view from the virtual viewpoint capturing another main object after switching the same.

It is also possible to select a position predetermined for the second object captured by the virtual camera after switching at the time of switching the position of the virtual viewpoint. For example, in a case where the virtual camera before switching is capturing the first object from behind, the virtual camera after switching may select a position to capture the second object from front.

Furthermore, although a case of image-capturing a soccer game is exemplified in the above-described embodiment, the image-capture target is not necessarily limited thereto. For example, it is also possible to apply the present embodiment to image-capturing of a game of another sport such as football, tennis, ice skating, and basketball, and musical performance such as a live and a concert.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiment, it is possible to smoothly start manipulation of a virtual viewpoint after switching the virtual viewpoint.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-080977, filed May 17, 2022, which is hereby incorporated by reference wherein in its entirety.

What is claimed is:

1. An information processing apparatus comprising:
one or more memories storing instructions; and
one or more processors executing the instructions to:
receive an instruction related to a virtual viewpoint for generating a virtual viewpoint image;
generate, in a case where the received instruction includes an instruction to switch from a first virtual viewpoint to a second virtual viewpoint, switching information indicating a positional relationship between the first virtual viewpoint and a first object included in a virtual viewpoint image corresponding to the first virtual viewpoint;
change, based on the switching information, a positional relationship between the second virtual viewpoint and a second object included in a virtual viewpoint image corresponding to the second virtual viewpoint to be similar to the positional relationship between the first virtual viewpoint and the first object; and
generate a virtual viewpoint image corresponding to the second virtual viewpoint changed according to the changed positional relationship.

2. The information processing apparatus according to claim 1, wherein
in the generating the switching information, the switching information is generated by using position line-of-sight information indicating a position of the first virtual viewpoint and a line-of-sight direction from the first virtual viewpoint.

3. The information processing apparatus according to claim 1, wherein
the switching information includes angle information indicating an angle formed between a specific direction based on the first object and a direction in which the first virtual viewpoint is positioned in a view from the first object.

4. The information processing apparatus according to claim 3, wherein
the switching information includes distance information indicating a distance between the first object and the first virtual viewpoint.

5. The information processing apparatus according to claim 3, wherein
the switching information includes line-of-sight information indicating a line-of-sight direction from the first virtual viewpoint based on the specific direction.

6. The information processing apparatus according to claim 1, wherein
in the changing, a position of the second virtual viewpoint and a line-of-sight direction from the second virtual viewpoint are changed based on a specific direction of the second object.

7. The information processing apparatus according to claim 2, wherein
in the changing, a position of the second virtual viewpoint and a line-of-sight direction from the second virtual viewpoint are changed by using first object information indicating size of a body of the first object and second object information indicating size of a body of the second object.

8. The information processing apparatus according to claim 1, wherein
the instruction includes position information indicating a position of the second virtual viewpoint and identification information on the second object.

9. The information processing apparatus according to claim 8, wherein
the identification information on the second object is identification information corresponding to an object determined based on the second virtual viewpoint.

10. The information processing apparatus according to claim 9, wherein
the identification information on the second object is identification information corresponding to an object nearest the position of the second virtual viewpoint.

11. The information processing apparatus according to claim 10, wherein
in a case where there are a plurality of objects nearest the position of the second virtual viewpoint, the identification information on the second object is identification information corresponding to an object determined according to a predetermined priority.

12. The information processing apparatus according to claim 1, wherein
the one or more processors execute the instructions further to:
display the virtual viewpoint image corresponding to the second virtual viewpoint on a first display unit.

13. The information processing apparatus according to claim 12, wherein
the virtual viewpoint image corresponding to the second virtual viewpoint is an image having a composition similar to the composition of the virtual viewpoint image corresponding to the first virtual viewpoint.

14. The information processing apparatus according to claim 12, wherein
in the receiving the instruction, the instruction for a bird's-eye image of a view of an image-capture target is received by a plurality of image-capture devices or a list table indicating a list of objects that can be associated with the second virtual viewpoint.

15. The information processing apparatus according to claim 1, wherein
the one or more processors execute the instructions further to:
control movement of the second virtual viewpoint by using the switching information.

16. The information processing apparatus according to claim 15, wherein
in the controlling movement of the second virtual viewpoint by using the switching information, a movement direction and a movement speed of the first object are calculated by using first object information in a predetermined time before receiving the instruction and the second virtual viewpoint is automatically controlled based on the calculation result.

17. The information processing apparatus according to claim 16, wherein
in the controlling movement of the second virtual viewpoint by using the switching information, control of the virtual viewpoint is switched to manual control in a case where in the receiving the instruction, manual manipulation is detected based on the instruction during the automatic control.

18. The information processing apparatus according to claim 1, wherein
the first object and the second object are the same.

19. An information processing method, comprising the steps of:
receiving an instruction related to a virtual viewpoint for generating a virtual viewpoint image;
generating, in a case where the instruction received by the receiving includes an instruction to switch from a first virtual viewpoint to a second virtual viewpoint, switching information indicating a positional relationship between the first virtual viewpoint and a first object included in a virtual viewpoint image corresponding to the first virtual viewpoint;
changing, based on the switching information, a positional relationship between the second virtual viewpoint and a second object included in a virtual viewpoint image corresponding to the second virtual viewpoint to be similar to the positional relationship between the first virtual viewpoint and the first object; and
generating a virtual viewpoint image corresponding to the second virtual viewpoint changed according to the changed positional relationship.

20. A non-transitory computer readable storage medium storing a program for causing a computer to perform a control method of controlling an information processing apparatus comprising:
one or more memories storing instructions; and
one or more processors executing the instructions to:
receive an instruction related to a virtual viewpoint for generating a virtual viewpoint image;
generate, in a case where the received instruction includes an instruction to switch from a first virtual viewpoint to a second virtual viewpoint, switching information indicating a positional relationship between the first virtual viewpoint and a first object included in a virtual viewpoint image corresponding to the first virtual viewpoint;
change, based on the switching information, a positional relationship between the second virtual viewpoint and a second object included in a virtual viewpoint image corresponding to the second virtual viewpoint to be similar to the positional relationship between the first virtual viewpoint and the first object; and
generate a virtual viewpoint image corresponding to the second virtual viewpoint changed according to the changed positional relationship.
